(19) United States
(12) Patent Application Publication
(10) Pub. No.: US 2013/0248572 A1
(43) Pub. Date: Sep. 26, 2013

(54) CONSOLE BOX WITH SLIDING FLOOR

(71) Applicant: Ronald W. Myers, Dublin, OH (US)

(72) Inventor: Ronald W. Myers, Dublin, OH (US)

(73) Assignee: Honda Motor Co., Ltd.

(21) Appl. No.: 13/427,989

(22) Filed: Mar. 23, 2012

(51) Int. Cl. B60R 7/00

(52) U.S. Cl. 224/539

(57) ABSTRACT

A center console box is dimensioned for receipt between laterally spaced seats in an automotive vehicle. Sidewalls and end walls cooperate with a bottom wall having a stepped configuration to accommodate a HVAC duct passing beneath the raised bottom wall portion of the console box. A slidable wall portion is laterally movable between a first, storage position where it resides beneath the first bottom wall portion, and a second, operative position disposed in generally side-by-side relation with the first bottom wall portion. This forms a hidden compartment in the extended depth portion of the cavity overlying the second bottom wall portion.

### BACKGROUND

This disclosure is directed to a storage compartment or console box of the type disposed between front seats in an automotive vehicle. More particularly, this disclosure relates to a console box in which the internal cavity may be reconfigured to accommodate different sized items for storage. It will be appreciated, however, that selected aspects of the present disclosure may find application in related environments and applications.

There is an increasing desire to provide a console box that accommodates larger items, for example, tablet computers, notebooks and laptop computers, etc. It is also desirable that the cavity not only accommodates larger items of this type, but also be able to cover the item when stored in the console box. Due to the relatively large size of tablet computers, a floor of the console box must be very low. In order to get a low floor in a console box, and simultaneously route or direct HVAC ducts underneath the console box, it becomes necessary to split the internal cavity into two levels. Customers have a concern that small items will fall into the lower portion of the split cavity, i.e. the deep portion of the console box. Thus there are competing concerns of providing storage for small items, preventing the small items from falling into the lower portion of the split cavity, and also being able to accommodate larger items such as a laptop computer that does not adversely impact on HVAC function in the vehicle.

One currently available design has a folding lid which stores along an interior side of the console box. The folding lid rotates downwardly to provide a second level surface to the console box spaced above the bottom surface. Unfortunately, this current design is expensive to manufacture, and requires the side of the box to be more narrow to allow the folding lid to be stored in the box. Further, this design also requires the folding lid to have two good appearance surfaces, i.e. both the top and bottom surfaces of the folding lid must have good appearances, because each of these surfaces is alternately visible when the folding lid is either in use or in a stowed, storage position.

Consequently, a need exists for a console box that overcomes these issues and others, and still satisfies the various desires of vehicle owners in a manner that is accommodating to HVAC concerns, aesthetics, cost, and the like.

### SUMMARY

A console box for an associated vehicle includes a bottom wall and sidewalls spaced apart to define a cavity. A slidable wall portion extends from a first, storage position to a second, extended position that overlies the bottom wall in spaced relation, the slidable wall portion defining an enlarged, continuous volume for the cavity in the first position and a split volume for the cavity each having a reduced dimension in the second position.

The bottom wall has a stepped configuration where a first portion of the bottom wall generally aligns with the slidable wall portion.

A vertical flange has a limited height provided along one edge of the slidable wall portion. The vertical flange extends above an upper surface of the first portion of the bottom wall so that the slidable wall portion can be extended into abutting engagement with an inner surface of the first sidewall and retracted into abutting engagement with the edge of the first portion of the bottom wall. In the retracted position, the slidable wall portion is substantially stored beneath the first portion of the bottom wall.

The first portion of the bottom wall is configured to overlie a duct that extends continuously therebeneath, and adjacent a second portion of the bottom wall located lower than the first portion.

The slidable wall portion covers the second portion of the bottom wall in the extended, second position to provide a hidden compartment.

A slot is dimensioned to receive the slidable wall portion therethrough, and preferably includes a channel assembly that receives opposite ends of the slidable wall portion, the slot communicating with and being disposed adjacent an underside surface of the first bottom wall portion.

The channel assembly is provided on an underside of the first portion of the bottom wall and dimensioned to receive the slidable wall portion.

One benefit of the present disclosure is the ability to store a large item such as a tablet computer in the console box.

Another advantage relates to the ability to close the console box once the large item is received therein and thereby hide the item from view.

Yet another benefit relates to the ability to route an HVAC duct underneath the console box.

Still another advantage is associated with retaining small items in an upper level of the console box and preventing such items from falling into the deep side of the console box when there is open access thereto.

A further advantage of the present disclosure is the more compact design of the cover or lid for the deep portion of the cavity in the console box.

Yet another benefit is that only one surface of the movable floor must have a good aesthetic appearance since the second surface is not visible.

Still other benefits and advantages of the present disclosure will become apparent upon reading and understanding the following detailed description.

### BRIEF DESCRIPTION OF THE DRAWINGS

FIG. 1 is a perspective view of a known console box assembly.

FIG. 2 is a perspective view illustrating some of the problems attempted to be resolved by the present disclosure.

FIG. 3 is a perspective view of still another problem attempt be resolved by the present disclosure.

FIG. 4 is a perspective view of the new console box assembly of the present its closure with the slidable wall extended to a second position.

FIG. 5 is a perspective view of an underside of the console box assembly of FIG. 4.

FIG. 6 is a perspective view showing insertion of a large item into a deep portion of the console box cavity.

FIG. 7 is a perspective view of the console box assembly with the slidable wall in the extended, second position.

### DETAILED DESCRIPTION

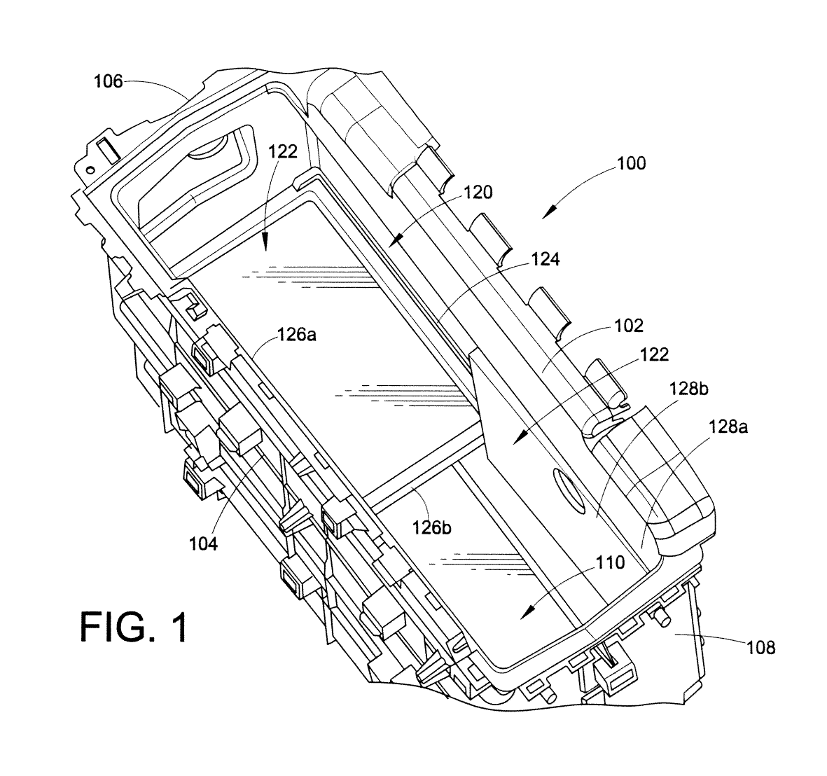

Initial reference is made to FIG. 1 which illustrates a console box or console box assembly 100. The console box 100 is typically located between the front seats in an automotive vehicle. Thus, the console box is generally centrally located and is limited in width due to the space between the seats, and has a limited length that generally corresponds to a length of a seat base, and has a limited depth because it is common to route a HVAC duct through this region from the front of the vehicle toward the rear seat(s). The console box 100 includes first and second sidewalls 102, 104 disposed in substantially parallel relation. The sidewalls 102, 104 are substantially perpendicular to first (front) and second (rear) end walls 106, 108. In addition, a substantially planar bottom wall 110 extends across and interconnects lower, terminal ends of the sidewalls 102, 104 and the end walls 106, 108. The bottom wall 110 forms a lower surface of an internal cavity 120 of the console box 100. A foldable wall 122 is pivotally mounted along one edge 124 to one of the sidewalls, shown here as the first sidewall 102. More particularly, the foldable wall 122 is mounted at approximately mid-height along the first sidewall 102. As shown, the foldable wall 122 includes first and second portions 126, 128 that may be independently pivoted between a first, upright position where the floor portion (126 or 128) folds along an interior surface of the sidewall 102 of the console box 100, and a second, horizontal position where the foldable wall forms a raised floor at a height spaced above the bottom wall 110. When folded downwardly, the floor portions 126, 128 reduce the depth of the console box 100 and allow the user to store small items. On other hand, when the floor portions 126, 128 are folded upwardly into the storage position, the overall cavity depth increases since uninhibited access is available to the bottom surface 110.

As is evident in FIG. 1, when folded into the upright, stored position, the foldable wall portions 126, 128 impact the overall total volume of the inner cavity 120. That is, the foldable wall portions 126, 128 use some of the total available volume of the inner cavity in the stored position. Moreover, by orienting the foldable wall portions 126, 128 in end-to-end fashion, both foldable wall portions must be in the storage position in order to accommodate a large item for storage in the console box.

Further, an upper surface 126a, 128a of each foldable wall portion is visible when the wall portions are folded downwardly to reduce the depth of the console box. Likewise, each of lower, underside surfaces 126b, 128b is also visible when each foldable wall portion is positioned in the upright, stored position. Consequently, for aesthetic reasons, each of the upper surfaces 126a, 128a and each of the underside surfaces 126b, 128b must have a good surface finish. This adds to the cost of the mold used to form the foldable wall portions and likewise adds to the overall cost to manufacture the console box.

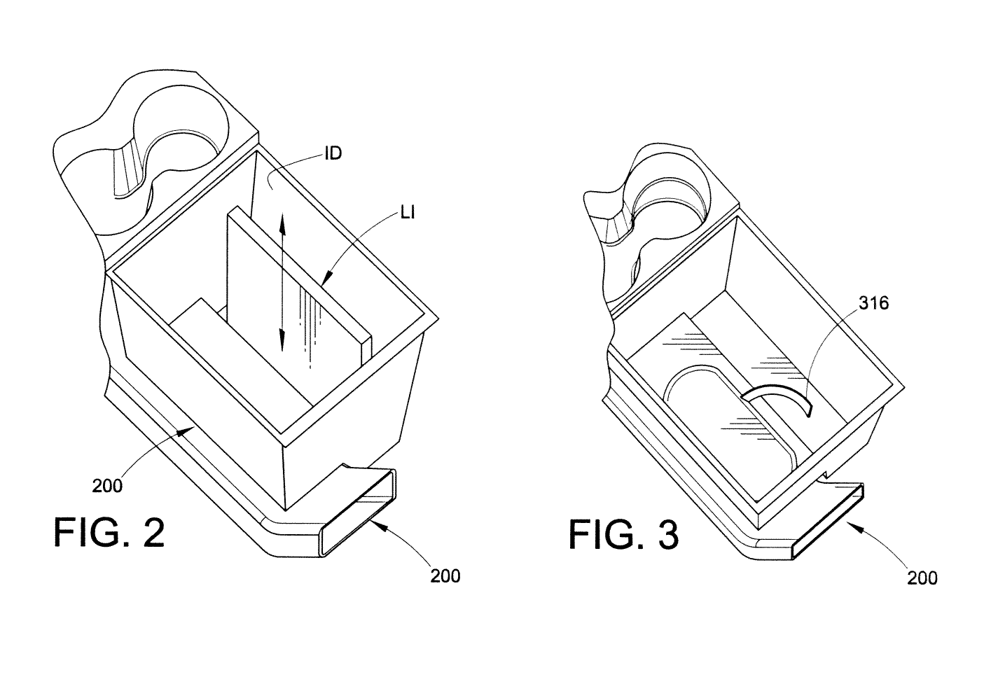

With continued reference to FIG. 1, and additional reference to FIGS. 2 and 3, the present disclosure attempts to resolve the illustrated problem issues, as well as others, facing the console box arrangement of FIG. 1. More specifically, FIG. 2 illustrates HVAC duct 200 that extends along the vehicle floor between the front seats to direct heat or air conditioned, cool air flow from the front of the vehicle to a location behind the front seats. Typically, the console box has a width that sits on top of the duct 200. As represented in FIGS. 2 and 3, the design or conformation of console box 300 is modified to accommodate the duct 200 while still addressing the need for an increased depth of the console box. In this preferred arrangement, the bottom wall or floor portion of the console box 300 has a stepped configuration. This stepped configuration provides side-by-side floor portions 310a, 310b at different heights, and likewise an increased depth associated with the side of the console box with the deeper floor portion 310b. The shallower depth on the other side of the console box 300 results from that portion of the stepped console box which is positioned over the HVAC duct 200. The increased depth is represented by reference numeral ID in FIG. 2 so that the console box can accommodate and is preferably dimensioned to receive larger items LI such as a tablet or laptop computer. Of course one skilled in the art will recognize that other large items LI may be stored in the console box, and particularly in that portion having an increased depth, without departing from the scope and intent of the present disclosure.

As represented in FIG. 3, small items could potentially fall into the increased depth portion when the large item LI is not stored in the console. This is represented by reference arrow 316.

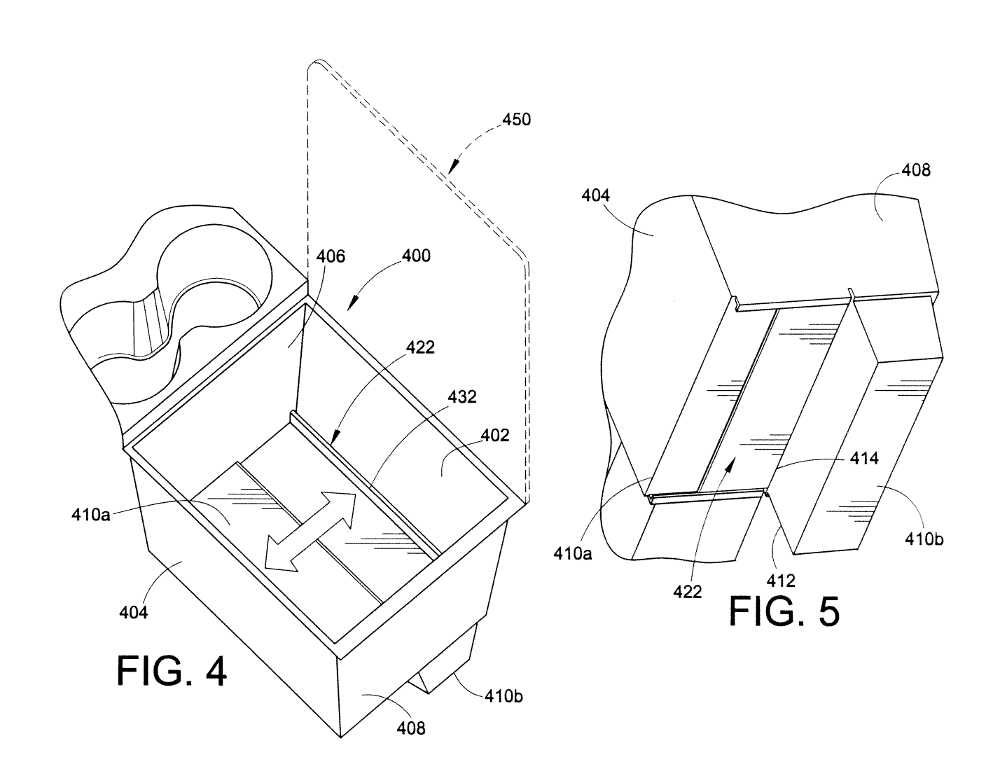

To resolve the issues of FIGS. 2-3, as well as other modifications, the console box 400 of the present disclosure as shown in FIGS. 4-7 is provided. Console box 400 includes first and second sidewalls 402, 404. The sidewalls 402, 404 are disposed in substantially parallel relation. Further, the sidewalls 402, 404 are substantially perpendicular to a first (front), end wall 406 and a second (rear), end wall 408. Lower edges of the sidewalls 402, 404 and end walls 406, 408, respectively, are joined by the stepped configuration of the bottom wall portions 410a (shallow), 410b (deep) which together define a bottom wall 410. The bottom wall portions 410a, 410b are spanned by a wall portion 412 that extends in a generally vertical direction, i.e., substantially parallel to the sidewalls 402, 404. The wall portion 412 includes a slot 414 at an upper end thereof and which is advantageously located adjacent and just below the bottom wall portion 410a. The sidewalls 402, 404, end walls 406, 408, and bottom wall portions 410a, 410b together enclose an internal cavity 420 for receiving and selectively storing items in the console box.

The slot 414 has a height dimension that closely receives a slidable wall portion 422. Preferably, opposite ends 424, 426 of the slidable wall portion 422 are received in respective first and second channels 428, 430. The channels 428, 430 are generally L-shaped configurations extending downwardly from the respective end walls 406, 408 to capture and provide sliding support for the opposite ends 424, 426 of the slidable wall portion 420. In a preferred arrangement, the slidable wall portion 422 has a generally planar conformation along an upper surface 422a with an upturned edge 432 extending upwardly therefrom. The upturned edge 432 has a height allowing the upturned edge to extend slightly above an upper surface of bottom wall portion 410a. The upturned edge 432 serves as a stop to limit sliding movement of the slidable wall portion 422 along and beneath the underside surface of bottom wall portion 410a. This is generally referred to as a retracted or stowed, first position where the slidable wall portion is substantially stored beneath the bottom wall portion 410a. When fully retracted beneath the bottom wall portion 410a, access is provided to the increased depth portion of the cavity 420, i.e. that portion of the cavity over bottom wall portion 410b. This permits a large item LI to be advantageously received in the cavity 420 and extend for a depth that substantially matches the full height of sidewall 402.

On the other hand, with a large item LI removed, the slidable wall portion 422 may be fully extended from beneath the bottom wall portion 410a such that the upturned edge 432 abuts against the inner surface of the first sidewall 402. This prevents smaller items that may be received on the upper surface of bottom wall portion 410a from inadvertently falling into the increased depth of the cavity defined by bottom wall portion 410b. This extended position of the slidable wall portion also forms a hidden compartment (i.e., between the bottom wall portion 401b and the extended slidable wall portion 422 in a vertical direction and between sidewall 402 and wall portion 412 in the lateral, horizontal direction).

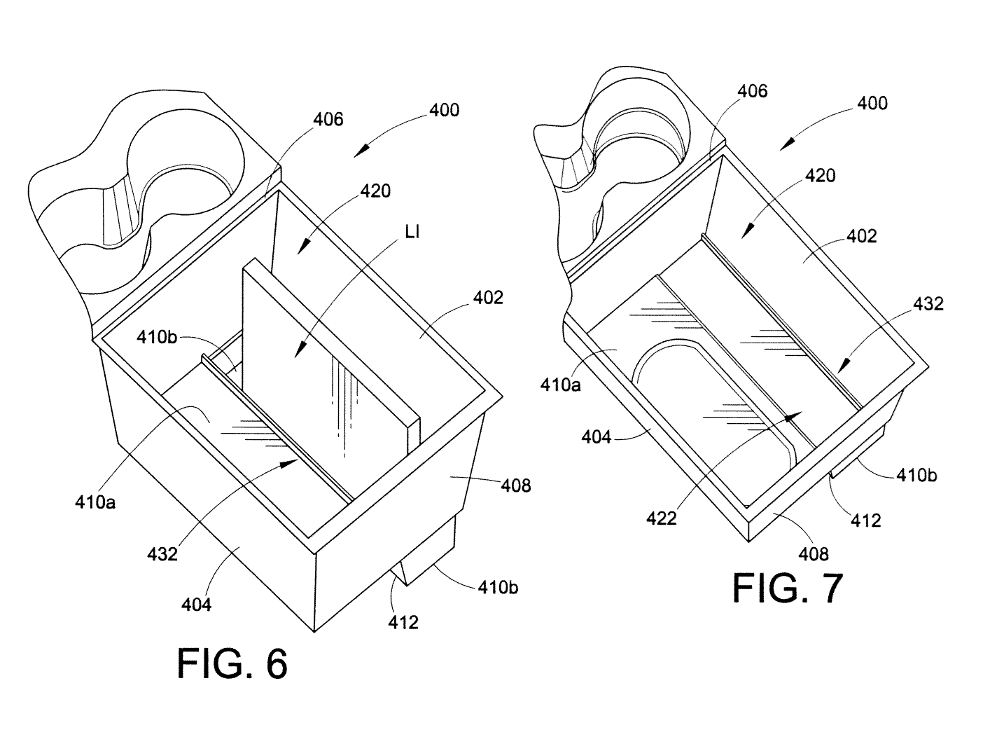

As will also be noted from FIGS. 4-7, smaller items can be effectively stored in the cavity 420 as shown in either FIG. 4 or 7, or larger items can be received as illustrated in FIG. 6. In either arrangement, a lid or cover 450 (shown in broken line in FIG. 4) may be closed over the upper edges of the sidewalls and end walls to limit access to, and view of, the interior cavity 420. This is true even if a large item LI is stored in the cavity 420.

Further, use of the slidable wall portion 422 requires only one of the surfaces to have a high grade finish since only the upper surface of the slidable wall portion will be exposed to view (FIGS. 4 and 7). The underside surface of the slidable wall portion 422 can have a rough finish since the underside surface will not be viewed by vehicle occupants (FIG. 5).

When the slidable wall portion 422 is fully retracted as shown in FIG. 6, a large item can be received in the increased depth side of the console box cavity 420. The upturned edge 432 of the slidable wall portion 422 extends a limited height above an upper surface of the wall portion 410a and can be easily moved by a user's fingers by engaging the upturned edge and urging the slidable wall portion toward the first sidewall 402. The slidable wall portion 422 is laterally movable between a first, storage or retracted position where it resides beneath the first bottom wall portion 410a, and a second, operative or extended position disposed in generally side-by-side relation with the first bottom wall portion. This extended position forms the hidden compartment formed in the extended depth portion of the cavity overlying the second bottom wall portion.

The disclosure has been described with reference to a preferred body meant. Obviously, modifications and alterations will occur to others upon reading and understanding the preceding detailed description. It is intended that the disclosure be construed as including all such modifications and alterations.

We claim:

1. A console box for an associated vehicle, the console box comprising:
a bottom wall and sidewalls spaced apart to define a cavity; and
a slidable wall portion that extends from a first, storage position to a second, extended position that overlies the bottom wall in spaced relation, the slidable wall portion defining an enlarged, continuous volume for the cavity in the first position and a reduced, split volume for the cavity in the second position.

2. The console box of claim I wherein the bottom wall has a stepped configuration wherein a first portion of the bottom wall generally aligns with the slidable wall portion.

3. The console box of claim 2 wherein the slidable wall portion includes a vertical flange that extends above an upper surface of the first portion of the bottom wall.

4. The console box of claim 3 wherein the vertical flange abuts against an elongated edge of the first portion of the bottom wall in the first position.

5. The console box of claim 2 further comprising a channel assembly provided on an underside of the first portion of the bottom wall dimensioned to receive the slidable wall portion.

6. The console box of claim 5 wherein the channel assembly dimensioned to support first and second ends of the slidable wall portion.

7. The console box of claim 2 wherein a second portion of the bottom wall is located below the first portion.

8. The console box of claim 1 wherein the first portion of the bottom wall is configured to overlie a duct that extends continuously therebeneath and adjacent the second portion of the bottom wall.

9. The console box of claim 1 wherein the slidable wall portion covers the second portion of the bottom wall in the second position to provide a hidden compartment.

10. A center console box assembly dimensioned for receipt between seats of an associated automotive vehicle, the center console box assembly comprising:
first, second, third and fourth sidewalls and a bottom wall configured to form a generally parallelepiped cavity, the bottom wall having a stepped conformation formed by first and second bottom wall portions disposed at respective first and second planes at a desired fixed height relative to one another, and the first sidewall having a split conformation formed by first and second first sidewall portions; and
a slidable wall portion movable between a first, stored position generally overlying the first bottom wall portion, and a second, extended position overlying the second bottom wall portion.

11. The center console box assembly of claim 10 wherein the slidable wall portion includes a flange extending along a first edge thereof that extends above the first plane.

12. The center console box assembly of claim 11 wherein the flange extends in a direction substantially perpendicular to a sliding direction of the slidable wall portion.

13. The center console box assembly of claim 10 further comprising a retainer for mounting the slidable wall portion to the first bottom wall portion.

14. The center console box assembly of claim 11 further comprising an elongated slot extending between the first and second portions of the first sidewall adjacent the first bottom wall portion.

15. The center console box assembly of claim 14 wherein the slot is dimensioned to receive the slidable wall portion therethrough.

16. The center console box assembly of claim 15 wherein the slot communicates with and is disposed along an underside surface of the first bottom wall portion.

17. The center console box assembly of claim 16 wherein the retainer includes channels disposed along an underside of the first bottom wall portion that receive opposed edges of the slidable wall portion.

18. A center console box assembly dimensioned for receipt between laterally spaced seats in an automotive vehicle, the center console box assembly comprising:
first, second, third, and fourth sidewalls, and a bottom wall forming a generally parallelepiped body having an inner cavity, the first sidewall having upper and lower portions laterally offset from one another, and the bottom wall having upper and lower portions spaced at different heights to accommodate a vent passage that passes beneath the lower portion of the bottom wall; and
a slidable wall portion that is laterally movable between a first, storage position in generally overlapping relation with the upper portion of the bottom wall, and a second, operative position in generally side-by-side relation with the upper portion of the bottom wall.

19. The center console box assembly of claim 18 further comprising a slot formed in the lower portion of the first sidewall beneath the upper portion of the bottom wall, and having a thickness dimension that slidingly receives the slidable wall portion.

20. The center console box assembly of claim 18 further comprising a flange extending upwardly from an edge of the slidable wall portion to a height above an upper surface of the first portion of the bottom wall.
